(19) United States
(12) Patent Application Publication
(10) Pub. No.: US 2009/0225162 A1
(43) Pub. Date: Sep. 10, 2009

(54) MONITORING APPARATUS

(75) Inventor: Chia-Chi Liu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: LUSTROUS INTERNATIONAL TECHNOLOGY LTD., Taipei County (TW)

(21) Appl. No.: 12/043,144

(22) Filed: Mar. 6, 2008

(51) Int. Cl. H04N 7/18

(52) U.S. Cl. 348/143; 348/E07.085

(57) ABSTRACT

A monitoring apparatus including a circuit board, a light emitting diode array, and a sensor is provided. The light emitting diode array and the sensor are disposed on the circuit board and are electrically connected with the circuit board.

### BACKGROUND OF THE INVENTION

1. Field of the Invention

The present invention generally relates to an anti-theft device, in particular, to a monitoring apparatus.

2. Description of Related Art

In the recent years, due to the soaring semiconductor technology, surveillance cameras utilizing cheap and reliable semiconductor device such as CMOS (complementary metal-oxide semiconductor) or CCD (charge-coupled device) have been widely used as anti-theft devices. A conventional monitoring apparatus includes a surveillance camera and an infrared light emitting device (LED) array. The infrared LED array projects an invisible light on the object, so the surveillance camera can capture the image and movement of the object even in dim ambient illumination, without the awareness of the object.

### SUMMARY OF THE INVENTION

Accordingly, the present invention is directed to a monitoring apparatus, which has a smaller volume and a lower manufacturing cost.

The present invention provides a monitoring apparatus including a circuit board, a light emitting diode array, and a sensor. The light emitting diode (LED) array and the sensor are disposed on the circuit board and are electrically connected with the circuit board.

According to an embodiment of the present invention, the monitoring apparatus further has a lens module disposed over the sensor.

According to an embodiment of the present invention, the lens module includes a lens holder and a lens. The lens holder is connected with the circuit board, while the lens is disposed on the lens holder and over the sensor.

According to an embodiment of the present invention, the circuit board has a plurality of through holes and the lens holders are assembled with the circuit board through the through holes.

According to an embodiment of the present invention, the monitoring apparatus further includes a flexible circuit board, electrically connected with the circuit board.

According to an embodiment of the present invention, the monitoring apparatus further includes a communication system disposed on the circuit board.

According to an embodiment of the present invention, the communication system is a voice controlling system.

According to an embodiment of the present invention, the communication system is remote control system.

According to an embodiment of the present invention, the LED array is an infrared LED array.

According to an embodiment of the present invention, the circuit board includes an aluminium board or a ceramic board.

According to an embodiment of the present invention, the sensor comprises a plurality of complementary metal-oxide semiconductor devices.

According to an embodiment of the present invention, the sensor comprises a plurality of charge-coupled devices.

As described above, in the present invention, the sensor and the LED array is disposed on the same circuit board, and thus achieve a smaller volume and lower cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a monitoring apparatus according to an embodiment of the present invention.

FIG. 2 illustrates a monitoring apparatus according to another embodiment of the present invention.

FIG. 3 is a cross-sectional view along line AA in FIG. 2A.

FIG. 4 is a block diagram of a monitoring apparatus according to another embodiment of the present invention.

FIG. 5 is a block diagram of a monitoring apparatus according to yet another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

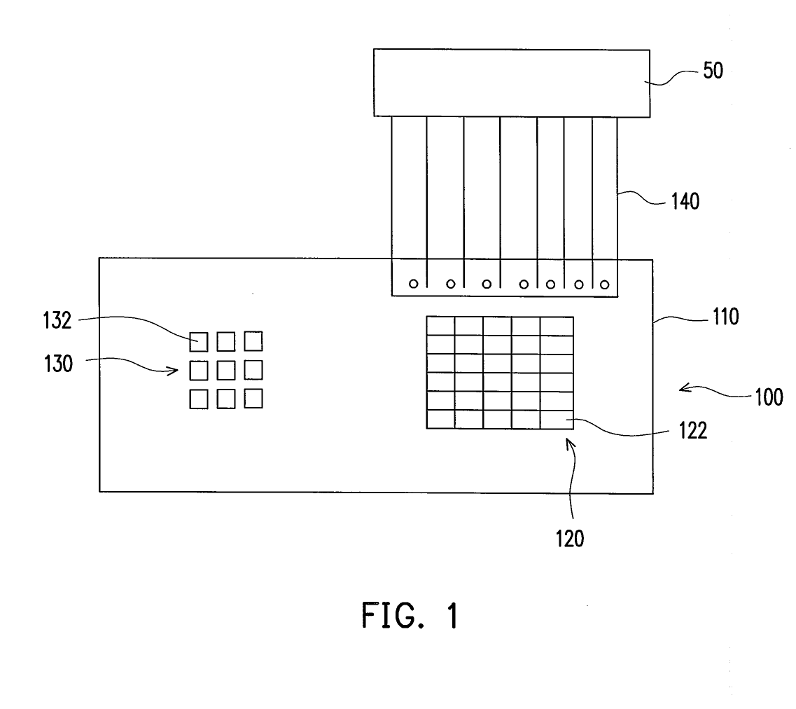

FIG. 1 illustrates a monitoring apparatus according to an embodiment of the present invention. Referring to FIG. 1, the monitoring apparatus 100 includes a circuit board 110, a sensor 120, and a light emitting diode (LED) array 130. Both of the light emitting diode array 130 and the sensor 120 are disposed on the circuit board 110 and electrically connected with the circuit board 110.

In the present embodiment, the sensor 120 may be an array of light sensing devices, such as CCDs (charge-coupled devices), or CMOS (complementary metal-oxide semiconductor) devices. The LED array 130 may consists of a plurality of LEDs, which may be infrared LEDs. The quantity of the LEDs in the LED array 130 is not limited by the present embodiment. People having ordinary skilled in the art should be able to arrange desired numbers of LEDs according to different situation, such as only one LED in the LED array. What is more, the LEDs 132 emitting light of other wavelengths are also applicable, such as visible light LEDs.

Moreover, in the present embodiment, the circuit board 110 may be an aluminium board. Nonetheless, in other embodiment, people having ordinary skill in the art may utilize other circuit boards, ceramic board among them.

Since the light emitting diode array 130 and the sensor 120 are disposed on the same circuit board 110, which leads to more compact structure and simpler manufacturing process. Thus, the monitoring apparatus 100 has a smaller volume and a lower cost.

Furthermore, in the present embodiment, the monitoring apparatus 100 may further include a flexible circuit board 140, which electrically connects between the circuit board 110 and the data storage 50, so that the data captured by the sensor can be stored in the data storage 50.

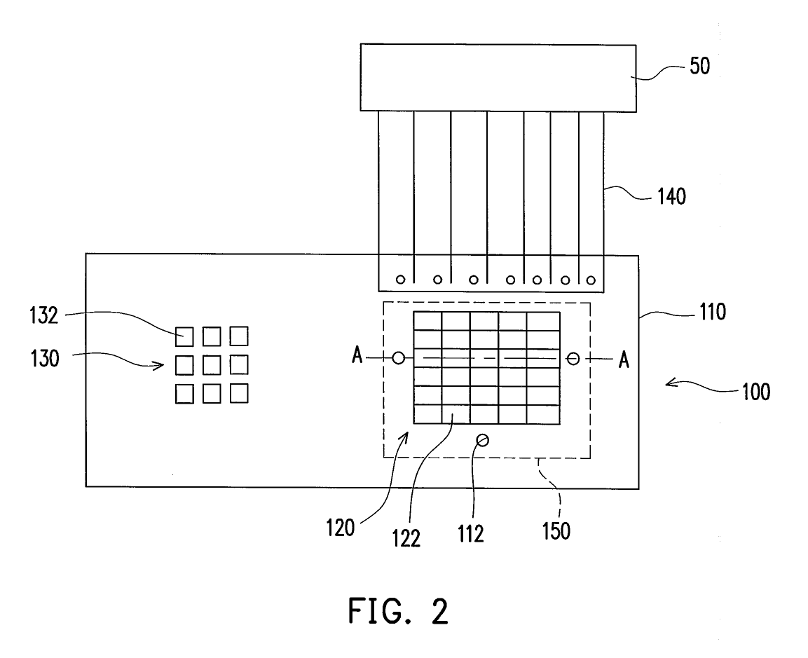

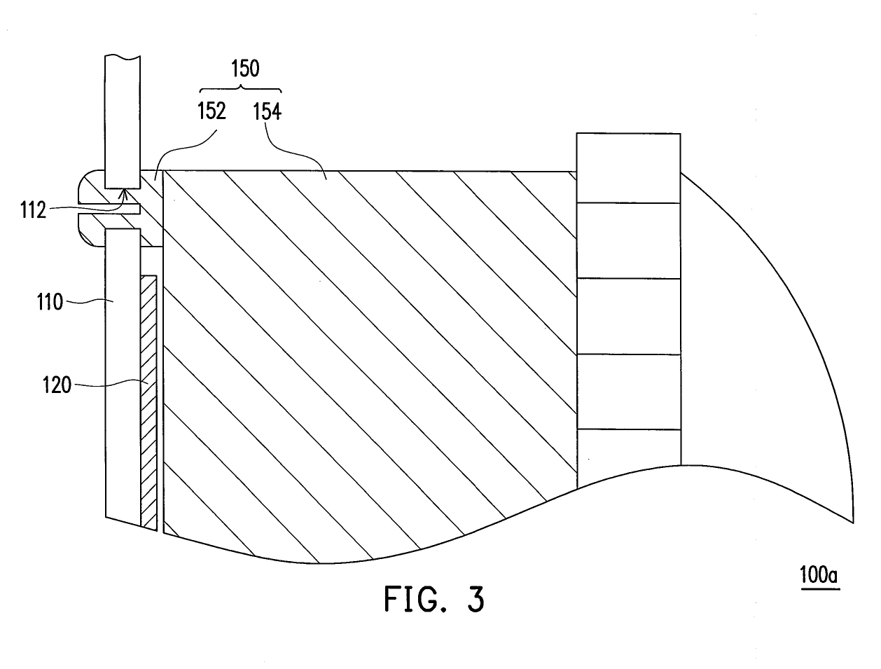

FIG. 2 illustrates a monitoring apparatus according to another embodiment of the present invention, and FIG. 3 is a cross-sectional view along line AA in FIG. 2. It is to be noticed that the following embodiment is partially similar to the embodiment shown in FIG. 1. In the following embodiment and the embodiment shown in FIG. 1, same or similar reference character refers to same or similar part. The difference between the following embodiment and the embodiment shown in FIG. 1 will be disclosed in the following paragraphs.

Referring to FIG. 2 and FIG. 3, in the present embodiment, the monitoring apparatus 100a may further include a lens module 150 disposed on the circuit board 110 and over the sensor 120. The lens module 150 may include a lens holder 152 and a lens 154. The lens holder 152 is connected with the circuit board 110, while the lens 154 is disposed on the lens holder 152 and over the sensor 120. The circuit board 110 may have a plurality of through holes 112, and the lens holder 152 is assembled with the circuit board 110 through the through holes 112.

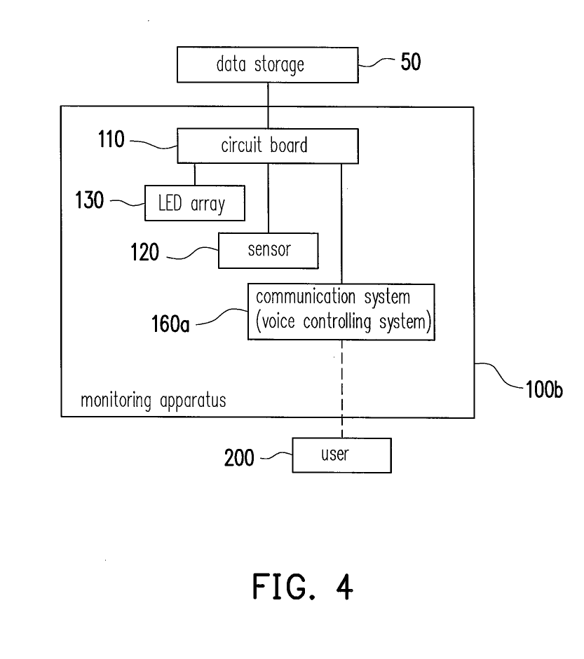

Moreover, the monitoring apparatus may have a communication system disposed on the circuit board. The users can use the communication system to control the monitoring apparatus. For example, the communication system maybe a voice controlling system or a remote control system. FIG. 4 is a block diagram of a monitoring apparatus according to another embodiment of the present invention. It is to be noticed that the following embodiment is partially similar to the embodiment shown in FIG. 1. In the following embodiment and the embodiment shown in FIG. 1, same or similar reference character refers to same or similar part. The difference between the following embodiment and the embodiment shown in FIG. 1 will be disclosed in the following paragraphs.

Referring to FIG. 4, in the present embodiment, the monitoring apparatus 100b further has a voice controlling system 160a, which is disposed on the circuit board 110 and electrically connected with the circuit board 110. Through the voice controlling system 160a the user 200 can control the monitoring apparatus 100b with voice commands. The communication system is not limited to voice controlling system 160a in the present embodiment, other controlling system, such as a remote control system is also applicable.

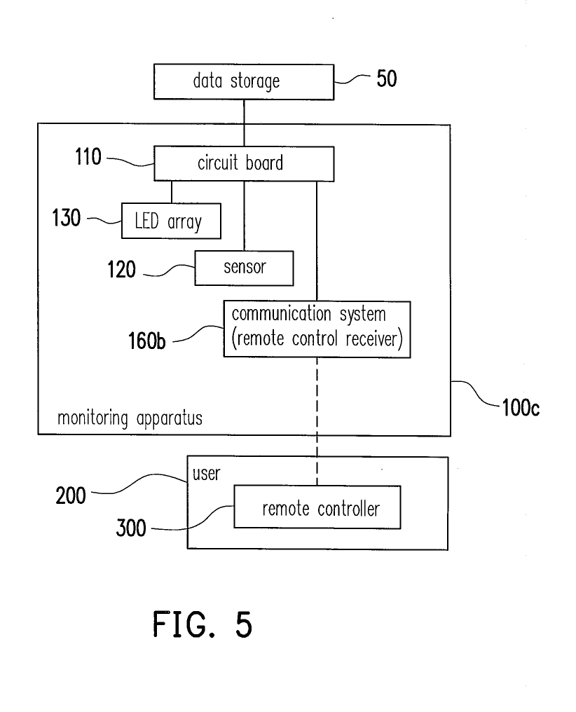

FIG. 5 is a block diagram of a monitoring apparatus according to yet another embodiment of the present invention. It is to be noticed that the following embodiment is partially similar to the embodiment shown in FIG. 4. In the following embodiment and the embodiment shown in FIG. 4, same or similar reference character refers to same or similar part. The difference between the following embodiment and the embodiment shown in FIG. 4 will be disclosed in the following paragraphs.

Referring to FIG. 5, in the present embodiment, a remote control receiver 160b is disposed on the circuit board 110 and electrically connected with the circuit board 110. The user 200 can use the remote control 300 to control the monitoring apparatus 100c.

In summary, in the present invention, the sensor and the LED array are disposed on the same circuit board, thorough such arrangement, the volume of the monitoring apparatus can be decreased, and the cost of the monitoring apparatus can be lowered.

Furthermore, the monitoring apparatus may have varieties of communication system disposed on the circuit board. Thus, the users can conveniently control the monitoring apparatus without increase the volume of the monitoring apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A monitoring apparatus, comprising:
a circuit board;
a light emitting diode (LED) array, disposed on the circuit board and electrically connected with the circuit board; and
a sensor, disposed on the circuit board and electrically connected with the circuit board.

2. The monitoring apparatus according to claim 1, further comprising a lens module disposed over the sensor.

3. The monitoring apparatus according to claim 2, wherein the lens module comprises:
a lens holder, connected with the circuit board; and
a lens, disposed on the lens holder and over the sensor.

4. The monitoring apparatus according to claim 3, wherein the circuit board has a plurality of through holes and the lens holders are assembled with the circuit board through the through holes.

5. The monitoring apparatus according to claim 1, further comprising a flexible circuit board, electrically connected with the circuit board.

6. The monitoring apparatus according to claim 1, further comprising a communication system disposed on the circuit board.

7. The monitoring apparatus according to claim 6, wherein the communication system is a voice controlling system.

8. The monitoring apparatus according to claim 1, wherein the communication system is a remote control system.

9. The monitoring apparatus according to claim 1, wherein the LED array is an infrared LED array.

10. The monitoring apparatus according to claim 1, wherein the circuit board comprises an aluminium board or a ceramic board.

11. The monitoring apparatus according to claim 1, wherein the sensor comprises a plurality of complementary metal-oxide semiconductor devices.

12. The monitoring apparatus according to claim 1, wherein the sensor comprises a plurality of charge-coupled devices.
